(19) United States
(12) Patent Application Publication
(10) Pub. No.: US 2002/0044648 A1
(43) Pub. Date: Apr. 18, 2002

(54) Methods and systems for efficient chained certification

(76) Inventor: Benjamin Arazi, Omer (IL)

Correspondence Address: James J. DeCarlo, Stroock & Stroock Lavan LLP, 180 Maiden Lane, New York, NY, 10038-4982, US

(21) Appl. No.: 09/816,159

(22) Filed: Mar. 22, 2001

(30) Foreign Application Priority Data
Mar. 23, 2000 (IL) 135246

(51) Int. Cl. H04L 9/30

(52) U.S. Cl. 380/30; 713/157; 380/277

(57) ABSTRACT

Method for effecting a chained key-issuing process over a finite group of points in which the discrete logarithm problem applies, wherein an issuing user (Useri), who possesses an issuing user public value (Ui) and an issuing user private key (xi), provides to a successor user (User(i+i)) a successor user public value (U(i+1)) and a successor user private key (x(i+i)), and where the issuing user, except for a Certifying Authority (CA), was a successor user in a preceding step in the chained key-issuing process, and where the Certifying Authority acts as the first issuing user in the chained key-issuing process.

### FIELD OF THE INVENTION

The present invention relates to systems and methods for efficiently chaining a certification in a PKI (Public Key Infrastructure), from a Certifying Authority to end users, using operations over elliptic curves and modular exponentiations over finite fields or groups.

### BACKGROUND OF THE INVENTION

The validity of public key cryptographic applications is based on the assumption that the public key Yi submitted by a user, termed Useri, is valid. That is, Yi is assumed to be undeniably associated with the identification details, termed IDi, of Useri. Verifying the validity of Yi is commonly done, by the recipient, by referring to a certificate, which is submitted by Useri together with Yi and IDi.

The certificate typically consists of the signature of a CA (Certifying Authority) on the association between Yi and IDi. In order to generate a certificate, the CA uses a private key, according to the concept of public key cryptography.

Upon receiving Yi and IDi and the certificate, the recipient verifies the correct association between Yi and IDi by referring to the certificate and effecting a signature verification procedure, using the public key of the CA.

When using digital signature procedures based on the discrete logarithm problem, the signature verification procedure is based on effecting two modular exponentiation operations, as is generally known to persons skilled in the art.

In a ‘chained certification’, a Useri attests the association between the public key and the identification details of another user, termed User(i+1). User(i+1) attests the association between the public key and the identification details of User(i+2), etc. (The index i refers to the hierarchical level, in a certification chain, of a user, with respect to the CA, who acts as User0.) Using customary certification approaches, Useri, starting with the CA who acts as User0, signs the association between the public key and the identification details of User(i+1) by generating an explicit signature, generating the certificate Cert(i+1). Using signature methods which are based on the discrete logarithm problem, a certificate Certi is a pair {ci,Bi}, where ci is a scalar and Bi is a group-element over which the discrete logarithm problem applies.

To verify the correct association between the public key of User(i+1) and identification details of User(i+1), a verifier needs to know the public keys and the identification details of all users from User1 to User(i+1). The verifier further needs to know the public key of the CA (as was said, the CA acts as User0) and all certificates from Cert1 to Cert(i+1). Based on these values, the verifier effects i+1 signature verification procedures, where each such signature verification requires two modular exponentiations. Altogether, the verifier performs 2(i+1) exponentiation operations.

The art has so far failed to provide means by which chained certificate verification can be effectively implemented by saving mathematical operations, permitting to use less computational operations in effecting certification verification.

It is therefore an object of the present invention to provide a method by which chained certificate verification can be carried out with high efficiency.

Other objects of the invention will become apparent as the description proceeds.

### SUMMARY OF THE INVENTION

The invention relates to a method for effecting a chained key-issuing process over a finite group of points in which the discrete logarithm problem applies, wherein an issuing user (Useri), who possesses an issuing user public value (Ui) and an issuing user private key (xᵢ), provides to a successor user (User(i+1)) a successor user public value (U(i+1)) and a successor user private key (x(i+1)), and where the issuing user, except for a Certifying Authority (CA), was a successor user in a preceding step in the chained key-issuing process, and where the Certifying Authority acts as the first issuing user in the chained key-issuing process. The method comprises the steps of:

(a) permitting the Certifying Authority to select a generating group-point (G) whose exponentiations to various powers generate various group-points and a converting mathematical operation (H) which converts several input values into a scalar;

(b) permitting the Certifying Authority to posses a Certifying Authority private key (x0);

(c) permitting the Certifying Authority to posses a Certifying Authority public value (U0), obtained by exponentiating the generating group-point to the power of the Certifying Authority private key (U0=x0*G);

(d) permitting the issuing user (Useri) to possess the generating group-point (G) and the converting mathematical operation (H) and the identification details (ID(i+1)) of the successor user;

(e) permitting the issuing user (Useri) to possess an issuing user private key (xi), where, except for the case in which the issuing user is the Certifying Authority, the issuing user private key was provided to the issuing user at a preceding stage in the chained key-issuing process (in which Useri acted as a successor user in respect to an issuing User(i−1));

(f) permitting the issuing user (Useri) to calculate the successor user public value (U(i+1)) and the successor user private key (x(i+1)) wherein:

a successor user random value (k(i+1)) is generated and the successor user public value (U(i+1)) is calculated by exponentiating the generating group-point to the power of the successor user random value (U(i+1)=k(i+1)*G);

a successor user representing value (H(ID(i+1),U(i+1))) is calculated by operating with the converting mathematical operation on the successor user identification details (ID(i+1)) and the successor user public value (U(i+1));

the successor user private key (x(i+1)) is calculated by multiplying the successor user representing value (H(ID(i+1),U(i+1))) by the successor user random value (k(i+1)) and adding the issuing user private key (xi) to the product obtained by a multiplication (x(i+1)=H(ID(i+1),U(i+1))*k(i+1)+xi) and reducing the result modulo the order of said generating group-point; and

(g) permitting said issuing the (Useri) to submit the successor user public value (U(i+1)) and the successor user private key (x(i+1)) to the successor user (User(i+1)).

According to a preferred embodiment of the invention, there is provided a method where the issuing user (Useri) does not know the successor user private key (x(i+1)), the above-described method further comprising the steps of:

(i) permitting the successor user (User(i+1)) to generate a first random value (m(i+1)) and calculate a first intermediate group-point (m(i+1)*G) by exponentiating the generating group-point to the power of the first random value;

(ii) permitting the successor user to submit the first intermediate group-point (m(i+1)*G) to the issuing user (Useri);

(iii) permitting the issuing user to calculate a successor user public value (U(i+1)) and a successor user intermediate private key (p(i+1)), wherein:

a second random value (k(i+1)) is generated and a second intermediate group-point (k(i+1)*G) is calculated by exponentiating the generating group-point to the power of said second random value;

the successor user public value (U(i+1)) is calculated by adding the first intermediate group-point and the second intermediate group-point (U(i+1)=m(i+1)*G+k(i+1)*G);

a successor user representing value (H(ID(i+1),U(i+1))) is calculated in the way described;

the successor user intermediate private key (p(i+1)) is calculated by multiplying the successor user representing value (H(ID(i+1),U(i+1))) by said second random value (k(i+1)) and adding the issuing user private key (xi) to the product obtained by the multiplication (p(i+1)=H(ID(i+1),U(i+1))*k(i+1)+xi) and reducing the result modulo the order of said generating group-point; and

(iv) permitting the successor user to generate the successor user private key (x(i+1)) by calculating the successor user representing value (H(ID(i+1),U(i+1))) in the way described and multiplying said successor user representing value by the first random value (m(i+1)) and adding the successor user intermediate private key (p(i+1)) to the product obtained by the multiplication (x(i+1)=H(ID(i+1),U(i+1))*m(i+1)+p(i+1)) and reducing the result modulo the order of the generating group-point.

In another embodiment, the invention is directed to a certificate generation system for permitting a generating user who is a successor user (User(i+1)) according to the aforementioned method of the invention, to issue a certificate to a general user (User(i+2)) where the certificate attests to the association between the general user public key (Y(i+2)) and the general user identification details (ID(i+2)), where the general user public key was issued to the general user according to any known public key cryptographic method, the system comprising:

means for permitting the generating user to generate a first random scalar (k(i+2));

means for permitting the generating user to calculate a first part of a certificate (T(i+2)) by exponentiating the generating group-point to the power of the first random scalar (T(i+2)=k(i+2)*G);

means for permitting the generating user to calculate a general user representing value (H(ID(i+2),Y(i+2),T(i+2))) by operating with the converting mathematical operation on the general user identification details (ID(i+2)) and the general user public key (Y(i+2)) and the first part of a certificate (T(i+2));

means for permitting the generating user to calculate a second part of a certificate (s(i+2)) by multiplying said general user representing value by the first random scalar (k(i+2)) and adding the private key (x(i+1)) of the generating user to the product obtained by the multiplication (s(i+2)=H(ID(i+2),Y(i+2),T(i+2))*k(i+2)+x(i+1)) and reducing the result modulo the order of the generating group-point; and

means for permitting the generating user to submit the certificate to the general user, the certificate being comprised of the first part of a certificate (T(i+2)) and the second part of a certificate (s(i+2)).

According to a preferred embodiment of the invention there is provided a chained certificate verification system for permitting a verifying user to verify the authenticity of the certificate (T(i+2) and s(i+2)) issued to the general user (User(i+2)), as defined above and elsewhere herein, the system comprising:

means for providing the verifying user with the certificate and with the general user public key (Y(i+2)) and with the general user identification details (ID(i+2)) and with the Certifying Authority public value (U0) and with a plurality of pairs of values (IDj and Uj) consisting of the identification details and public values of all users (Userj, j=1, 2, . . . , i+1)) in the chained key-issuing process described above and elsewhere herein, starting with the first successor user (User1) after the Certifying Authority and ending with the generating user (User(i+1)) as hereinbefore and hereafter defined;

means for permitting the verifying user to verify the validity of the certificate, wherein:

a first scalar (H(ID(i+2),Y(i+2),T(i+2))) is calculated by operating with the converting mathematical operation on the general user identification details (ID(i+2)) and the general user public key (Y(i+2)) and the first part of the certificate (T(i+2));

a first intermediate group-point (H(ID(i+2),Y(i+2),T(i+2))*T(i+2)) is calculated by exponentiating the first part of the certificate (T(i+2)) to the power of the first scalar;

users representing values (H(IDj,Uj), j=1, 2, . . . , i+1) are calculated by operating with the converting mathematical operation on each pair of the plurality of pairs of values (IDj and Uj);

users temporary group-points (H(IDj,Uj)*Uj, j=1, 2, . . . , i+1) are calculated for each user in the chained key-issuing process, starting with the first successor user (User1) and ending with the generating user (User(i+1)), by exponentiating each the user public value (Uj) to the power of the user representing value (H(IDj,Uj));

a second intermediate group-point (P) is calculated by adding all users temporary group-points (P=H(ID(i+1),U(i+1))*U(i+1)+H(IDi,Ui)*Ui+H(ID(i−1),U(i−1))*U(i−1)+ . . . +H(ID1,U1)*U1);

a third intermediate group-point (Q) is calculated by adding the first intermediate group-point and the second intermediate group-point and the public value of said Certifying Authority (Q=H(ID(i+2),Y(i+2),T(i+2))*T(i+2)+P+U0);

a fourth intermediate group-point (s(i+2)*G) is calculated by exponentiating the generating group-point to the power of the first part (s(i+2)) of the certificate;

the value of the fourth intermediate group-point (s(i+2)*G) is compared to that of the third intermediate group-point (Q) and the certificate is determined as being valid in the case of equality.

In a further embodiment, the present invention is directed to a chained signature generation and verification system for permitting a successor user (User(i+1)) according to the method of the invention, to generate a signature and permitting a verifying party to verify the signature, the system comprising:

means for permitting the successor user (User(i+1)) to generate a signature on a message (m) wherein:

a first scalar (k) is randomly generated;

a first part of a signature (T) is generated by exponentiating the generating group-point to the power of said first scalar (T=k*G);

a representing value (H(m,T)) is generated by operating with the converting mathematical operation on the message (m) and the first part of a signature (T);

a second part of a signature (s) is calculated by multiplying the representing value (H(m,T)) by the first scalar (k) and adding the private key of the successor user (x(i−1)) to the product obtained by the multiplication (s=H(m,T)*k+x(i+1)) and reducing the result modulo the order of said generating group-point;

means for permitting the successor user to submit the message (m) and the signature (T and s) to the verifying party, the signature comprising of the first part of a signature (T) and the second part of a signature (s);

means for providing the verifying party with the Certifying Authority public value (U0) and with a plurality of pairs of values (IDj and Uj) consisting of the identification details and public values (IDj and Uj) of all users (Userj, j=1, 2, . . . , i+1)) in the chained key-issuing process as hereinbefore and hereafter described, starting with the first successor user (User1) after the Certifying Authority and ending with the successor user (User(i+1)); and

means for permitting the verifying party to verify the validity of the signature (T and s) on said message (m), wherein:

the representing value (H(m,T)) is generated in the way described;

a first intermediate group-point (H(m,T)*T) is calculated by exponentiating the first part of the signature (T) to the power of the representing value;

users representing values (H(IDj,Uj), j=1, 2, . . . , i+1) are calculated by operating with the converting mathematical operation on each pair of the plurality of pairs of values (IDj and Uj);

users temporary group-points (H(IDj,Uj)*Uj, j=1, 2, . . . , i+1) are calculated for each user in the chained key-issuing process, starting with the first successor user (User1) and ending with the successor user (User(i+1)), by exponentiating each the user public value (Uj) to the power of the user representing value (H(IDj,Uj));

a second intermediate group-point (P) is calculated by adding all the temporary group-points (P=H(ID(i+1),U(i+1))*U(i+1)+H(IDi,Ui)*Ui+H(ID(i−1),U(i-1))*U(i−1)+ . . . +H(ID1,U1)*U1);

a third intermediate group-point (Q) is calculated by adding the first intermediate group-point and the second intermediate group-point and the public value of said Certifying Authority (Q=H(m,T)*T+P+U0);

a fourth intermediate group-point (s*G) is calculated by exponentiating the generating group-point to the power of the first part (s) of said signature;

the value of the fourth intermediate group-point (s*G) is compared to that of the third intermediate group-point (Q) and the signature is determined as being valid in the case of equality.

### DETAILED DESCRIPTION OF PREFERRED EMBODIMENTS

All the above and other characteristics and advantages of the invention, though clear to the skilled person from the disclosure provided herein, will be better understood through the following illustrative and non-limitative description of preferred embodiments thereof.

The implementations rely on a finite group of points over which the discrete logarithm problem applies.

The following notations and terms are used throughout the description of the various embodiments of this invention:

The term “group-point” refers to an element of a finite group of points in which the discrete logarithm problem applies.

A group-point is denoted in bold.

s*P is a group-point obtained by exponentiating the group-point P to the power s.

A ‘scalar’ is a value which acts as an exponent. It is denoted by lower-case letters.

The ‘+’ notation in the expression s*P+t*Q means an addition of two group-points under the specific features of said finite group of points.

G denotes a generating group-point, joint to all users of a given system.

LogP is the scalar k such that P=k*G. Note that log(A+B)=LogA+LogB.

Scalars are calculated modulo the order of G.

Useri refers to the i-th user in a certification chain (in which the CA is User0).

xi—refers to the private key of Useri.

Ui—refers to the public value of Useri. Useri, except for User0 (which is the CA), does not know logUi.

H(c,B,D), H(c,B), H(B) refers to a mathematical operation, known to the CA and to all users, that converts a scalar and two group-points, or a scalar and a group-point, or a group-point, into a scalar. For the case of operating over elliptic-curves, a preferred implementation of the operation H(B) is taking the value of the x-coordinate of the group-point B.

A preferred first embodiment of this invention is directed to a chained key-issuing method wherein a user, termed Useri, provides personal keys to another user, termed User(i+1), and where the Certifying Authority, termed CA, acts as User0. The personal keys, which consist of a private key x(i+1) and a public value U(i+1) and which are distinct for each user, are provided for the purpose of effecting public key cryptographic operations over a finite group of points in which the discrete logarithm problem applies.

The identification details of said User(i+1) are termed ID(i+1). The private key of said Useri is a scalar xi.

Useri performs the following operations: generate a random k(i+1); calculate U(i+1)=k(i+1)*G, for a generating group-point G, joint to all users; calculate x(i+1)=H(ID(i+1),U(i+1))*k(i+1)+xi; and where H(c,B) is a compressing mathematical operation, known to the CA and to all users, that converts the group-point B and a scalar c into a scalar. x(i+1), like other scalars calculated in the processes included in this invention, is calculated modulo the order of said generating group-point G, as will be clear to persons skilled in the art.

Useri issues said values x(i+1) and U(i+1) to User(i+1). These two values serve, respectively, as the user's private value and the user's public value. In this case, the private key x(i+1) of User(i+1) is known to Useri.

User(i+1) is also provided with the public value U0 of the CA and the identification details IDj and public values Uj, for j=1, 2, . . . , i. That is, User(i+1) is provided with the identification details and public values of all users that preceded him in the certification chain.

User(i+1) can establish the validity of values x(i+1) and U(i+1) issued by Useri by checking whether x(i+1)*G=H(ID(i+1),U(i+1))*U(i+1)+H(IDi,Ui)*Ui+H(ID(i−1),U(i−1))*U(i−1)+ . . . +H(ID1,U1)*U1+U0.

A preferred second embodiment of this invention is directed to a method, which is an alternative to the method according to first embodiment of this invention, by which Useri provides personal keys to User(i+1).

According to the preferred second embodiment of this invention, and using the same notations used in the first embodiment, User(i+1) generates a random m(i+1) and submits m(i+1)*G to Useri. Useri performs the following operations: generate a random k(i+1); calculate k(i+1)*G and U(i+1)=m(i+1)*G+k(i+1)*G; and calculate p(i+1)=H(ID(i+1),U(i+1))*k(i+1)+xi. Useri issues said values p(i+1) and U(i+1) to User(i+1). User(i+1) generates his private key x(i+1)=p(i+1)+H(ID(i+1),U(i+1))*m(i+1). That is: x(i+1)=H(ID(i+1),U(i+1))*(k(i+1)+m(i+1))+xi. User(i+1) can establish the validity of the values p(i+1) and U(i+1) issued to him by Useri checking whether p(i+1)*G=H(ID(i+1),U(i+1))*(k(i+1)*G)+H(IDi,Ui)*Ui+H(ID(i−1),U(i−1))*U(i−1)+ . . . +H(IDi,Ui)*U1+U0. (User(i+1) calculates k(i+1)*G by subtracting m(i+1)*G from U(i+1).)

The method according to the preferred second embodiment of this invention does not allow Useri to know the private key x(i+1) of User(i+1), unlike the method according to the preferred first embodiment of this invention.

A preferred third embodiment of this invention is directed to a certificate generation system wherein User(i+1) according to the preferred first or second embodiments of this invention certifies the association between the public key Y(i+2) and the identification details ID(i+2) of a user termed User(i+2). Public key Y(i+2) can serve in any general public key cryptographic method, and it is not necessarily issued by said User(i+1) or effected by the certificate generation system.

User(i+1) generates a random k(i+2) and the certificate, which consists of the pair of values {T(i+2),s(i+2)}, where T(i+2)=k(i+2)*G and s(i+2)=H(ID(i+2),Y(i+2),T(i+2))*k(i+2)+x(i+1).

A preferred fourth embodiment of this invention is directed to a chained certificate verification system wherein a general user verifies the association between the public key Y(i+2) and the identification details ID(i+2) of the user User(i+2) defined in the preferred third embodiment of this invention.

To effect the chained certificate verification, the general user is provided with values ID(i+1) and Y(i+1), the certificate, which consists of the pair of values {s(i+2),T(i+2)}, the public value U0 of the CA, and the reference information IDj and Uj, j=1, 2, . . . , i+1. The general user then checks whether s(i+2)*G=H(ID(i+2),Y(i+2),T(i+2))*T(i+2)+H(ID(i+1),U(i+1))*U(i+1)+H(IDi,Ui)*Ui+H(ID(i−1),U(i−1))*U(i−1)+ . . . +H(ID1,U1)*U1+U0.

A preferred fifth embodiment of this invention is directed to a chained signature generation and verification system wherein User(i+1) according to the preferred first or second embodiments of this invention signs a message m. User(i+1) signs the message m by generating the signature which consists of the pair of values {T,s}, where T=k*G for a random k, and s=H(m,T)*k+x(i+1).

A general user, provided with signature {T,s}, effects a chained signature verification based on the public value U0 of the CA and the reference information IDj and Uj, j=1, 2, . . . , i+1. The general user checks whether s*G=H(m,T)*T+H(ID(i+1),U(i+1))*U(i+1)+H(IDi,Ui)*Ui+H(ID(i−1),U(i−1))*U(i−1)+ . . . +H(IDi,Ui)*U1+U0.

A preferred sixth embodiment of this invention is directed to an alternative to any of the first through fifth preferred embodiments of this invention, in which the identification details of a user are not being used.

According to the preferred sixth embodiment of this invention, any notation of the form H(IDi,Ui)*Ui or H(IDi,Yi,Ti), used in any of the first through fifth preferred embodiments of this invention, is respectively replaced by H(Ui)*Ui or H(Yi,Ti).

All the above description of preferred embodiments has been provided for the purpose of illustration, and is not intended to limit the invention in any way. Many variations can be made in the various methods and systems of the invention, without exceeding its scope.

What is claimed is:

1. A method for effecting a chained key-issuing process over a finite group of points in which the discrete logarithm problem applies, wherein an issuing user (Useri), who possesses an issuing user public value (Ui) and an issuing user private key (xi), provides to a successor user (User(i+1)) a successor user public value (U(i+1)) and a successor user private key (x(i+1)), and where said issuing user, except for a Certifying Authority (CA), was a successor user in a preceding step in the chained key-issuing process, and where said Certifying Authority acts as the first issuing user in the chained key-issuing process, said method comprising the steps of:
(a) permitting said Certifying Authority to select a generating group-point (G) whose exponentiations to various powers generate various group-points and a converting mathematical operation (H) which converts several input values into a scalar;
(b) permitting said Certifying Authority to posses a Certifying Authority private key (x0);
(c) permitting said Certifying Authority to posses a Certifying Authority public value (U0), obtained by exponentiating said generating group-point to the power of said Certifying Authority private key (U0=x0*G);
(d) permitting said issuing user (Useri) to possess said generating group-point (G) and said converting mathematical operation (H) and the identification details (ID(i+1)) of said successor user;
(e) permitting said issuing user (Useri) to possess an issuing user private key (xi), where, except for the case in which said issuing user is said Certifying Authority, said issuing user private key was provided to said issuing user at a preceding stage in the chained key-issuing process (in which Useri acted as a successor user in respect to an issuing User(i−1));
(f) permitting said issuing user (Useri) to calculate said successor user public value (U(i+1)) and said successor user private key (x(i+1)) wherein:
a successor user random value (k(i+1)) is generated and said successor user public value (U(i+1)) is calculated by exponentiating said generating group-point to the power of said successor user random value (U(i+1)=k(i+1)*G);
a successor user representing value (H(ID(i+1),U(i+1))) is calculated by operating with said converting mathematical operation on said successor user identification details (ID(i+1)) and said successor user public value (U(i+1));
said successor user private key (x(i+1)) is calculated by multiplying said successor user representing value (H(ID(i+1),U(i+1))) by said successor user random value (k(i+1)) and adding said issuing user private key (xi) to the product obtained by said multiplication (x(i+1)=H(ID(i+1),U(i+1))*k(i+1)+xi) and reducing the result modulo the order of said generating group-point; and
(g) permitting said issuing user (Useri) to submit said successor user public value (U(i+1)) and said successor user private key (x(i+1)) to said successor user (User(i+1)).

2. A method for effecting a chained key-issuing process as recited in claim 1, where the issuing user (Useri) does not know the successor user private key (x(i+1)), said method further comprising the steps of:
permitting said successor user (User(i+1)) to generate a first random value (m(i+1)) and calculate a first intermediate group-point (m(i+1)*G) by exponentiating the generating group-point to the power of said first random value;
permitting said successor user to submit said first intermediate group-point (m(i+1)*G) to said issuing user (Useri);
permitting said issuing user to calculate a successor user public value (U(i+1)) and a successor user intermediate private key (p(i+1)), wherein:
a second random value (k(i+1)) is generated and a second intermediate group-point (k(i+1)*G) is calculated by exponentiating said generating group-point to the power of said second random value;
said successor user public value (U(i+1)) is calculated by adding said first intermediate group-point and said second intermediate group-point (U(i+1)=m(i+1)*G+k(i+1)*G);
a successor user representing value (H(ID(i+1),U(i+1))) is calculated in the way described;
said successor user intermediate private key (p(i+1)) is calculated by multiplying said successor user representing value (H(ID(i+1),U(i+1))) by said second random value (k(i+1)) and adding the issuing user private key (xi) to the product obtained by said multiplication (p(i+1)=H(ID(i+1),U(i+1))*k(i+1)+xi) and reducing the result modulo the order of said generating group-point; and
permitting said successor user to generate the successor user private key (x(i+1)) by calculating said successor user representing value (H(ID(i+1),U(i+1))) in the way described and multiplying said successor user representing value by said first random value (m(i+1)) and adding said successor user intermediate private key (p(i+1)) to the product obtained by said multiplication (x(i+1)=H(ID(i+1),U(i+1))*m(i+1)+p(i+1)) and reducing the result modulo the order of said generating group-point.

3. A certificate generation system for permitting a generating user who is a successor user (User(i+1)) to issue a certificate to a general user (User(i+2)) where said certificate attests to the association between said general user public key (Y(i+2)) and said general user identification details (ID(i+2)), where said general user public key was issued to said general user according to any known public key cryptographic method, wherein an issuing user (Useri), who possesses an issuing user public value (Ui) and an issuing user private key (xi), provides to a successor user (User(i+1)) a successor user public value (U(i+1)) and a successor user private key (x(i+1)), and where said issuing user, except for a Certifying Authority (CA), was a successor user in a preceding step in the chained key-issuing process, and where said Certifying Authority acts as the first issuing user in the chained key-issuing process, said system comprising:
means for permitting said generating user to generate a first random scalar (k(i+2));
means for permitting said generating user to calculate a first part of a certificate (T(i+2)) by exponentiating the generating group-point to the power of said first random scalar (T(i+2)=k(i+2)*G);
means for permitting said generating user to calculate a general user representing value (H(ID(i+2),Y(i+2),T(i+2))) by operating with the converting mathematical operation on said general user identification details (ID(i+2)) and said general user public key (Y(i+2)) and said first part of a certificate (T(i+2));
means for permitting said generating user to calculate a second part of a certificate (s(i+2)) by multiplying said general user representing value by said first random scalar (k(i+2)) and adding the private key (x(i+1)) of said generating user to the product obtained by said multiplication (s(i+2)=H(ID(i+2),Y(i+2),T(i+2))*k(i+2)+x(i+1)) and reducing the result modulo the order of said generating group-point; and
means for permitting said generating user to submit said certificate to said general user, said certificate comprising of said first part of a certificate (T(i+2)) and said second part of a certificate (s(i+2)).

4. A chained certificate verification system for permitting a verifying user to verify the authenticity of a certificate (T(i+2) and s(i+2)) issued to a general user (User(i+2)) where said certificate attests to the association between said general user public key (Y(i+2)) and said general user identification details (ID(i+2)), where said general user public key was issued to said general user according to any known public key cryptographic method, the system comprising:
means for providing said verifying user with said certificate and with the general user public key (Y(i+2)) and with the general user identification details (ID(i+2)) and with the Certifying Authority public value (U0) and with a plurality of pairs of values (IDj and Uj) consisting of the identification details and public values of all users (Userj, j=1, 2, . . . , i+1)) in the chained key-issuing process over a finite group of points in which the discrete logarithm problem applies, wherein an issuing user (Useri), who possesses an issuing user public value (Ui) and an issuing user private key (xi), provides to a successor user (User(i+1)) a successor user public value (U(i+1)) and a successor user private key (x(i+1)), and where said issuing user, except for a Certifying Authority (CA), was a successor user in a preceding step in the chained key-issuing process, and where said Certifying Authority acts as the first issuing user in the chained key-issuing process, starting with the first successor user (User1) after the Certifying Authority and ending with the successor user (User(i+1));
means for permitting said verifying user to verify the validity of said certificate, wherein:
a first scalar (H(ID(i+2),Y(i+2),T(i+2))) is calculated by operating with the converting mathematical operation on said general user identification details (ID(i+2)) and said general user public key (Y(i+2)) and the first part of said certificate (T(i+2));
a first intermediate group-point (H(ID(i+2),Y(i+2),T(i+2))*T(i+2)) is calculated by exponentiating said first part of the certificate (T(i+2)) to the power of said first scalar;
users representing values (H(IDj,Uj), j=1, 2, . . . , i+1) are calculated by operating with said converting mathematical operation on each pair of said plurality of pairs of values (IDj and Uj);
users temporary group-points (H(IDj,Uj)*Uj, j=1, 2, . . . , i+1) are calculated for each user in said chained key-issuing process, starting with said first successor user (User1) and ending with said generating user (User(i+1)), by exponentiating each said user public value (Uj) to the power of said user representing value (H(IDj,Uj));
a second intermediate group-point (P) is calculated by adding all said users temporary group-points (P=H(ID(i+1),U(i+1))*U(i+1)+H(IDi,Ui)*Ui+H(ID(i−1),U(i−1))*U(i−1)+ . . . +H(ID1,U1)*U1);
a third intermediate group-point (Q) is calculated by adding said first intermediate group-point and said second intermediate group-point and the public value of said Certifying Authority (Q=H(ID(i+2),Y(i+2),T(i+2))*T(i+2)+P+U0);
a fourth intermediate group-point (s(i+2)*G) is calculated by exponentiating the generating group-point to the power of the first part (s(i+2)) of said certificate;
the value of said fourth intermediate group-point (s(i+2)*G) is compared to that of said third intermediate group-point (Q) and the certificate is determined as being valid in the case of equality.

5. A chained signature generation and verification system for permitting a successor user (User(i+1)) to generate a signature and permitting a verifying party to verify said signature, wherein an issuing user (Useri), who possesses an issuing user public value (Ui) and an issuing user private key (xi), provides to a successor user (User(i+1)) a successor user public value (U(i+1)) and a successor user private key (x(i+1)), and where said issuing user, except for a Certifying Authority (CA), was a successor user in a preceding step in a chained key-issuing process, and where said Certifying Authority acts as the first issuing user in the chained key-issuing process, the system comprising:
means for permitting said successor user (User(i+1)) to generate a signature on a message (m) wherein:
a first scalar (k) is randomly generated;
a first part of a signature (T) is generated by exponentiating the generating group-point to the power of said first scalar (T=k*G);
a representing value (H(m,T)) is generated by operating with the converting mathematical operation on said message (m) and said first part of a signature (T);
a second part of a signature (s) is calculated by multiplying said representing value (H(m,T)) by said first scalar (k) and adding the private key of said successor user (x(i+1)) to the product obtained by said multiplication (s=H(m,T)*k+x(i+1)) and reducing the result modulo the order of said generating group-point;
means for permitting said successor user to submit said message (m) and said signature (T and s) to said verifying party, said signature comprising of said first part of a signature (T) and said second part of a signature (s);
means for providing said verifying party with the Certifying Authority public value (U0) and with a plurality of pairs of values (IDj and Uj) consisting of the identification details and public values (IDj and Uj) of all users (Userj, j=1, 2, . . . , i+1)) in the chained key-issuing process, starting with the first successor user (User1) after the Certifying Authority and ending with said successor user (User(i+1));
means for permitting said verifying party to verify the validity of said signature (T and s) on said message (m), wherein:
said representing value (H(m,T)) is generated in the way described;
a first intermediate group-point (H(m,T)*T) is calculated by exponentiating said first part of the signature (T) to the power of said representing value;
users representing values (H(IDj,Uj), j=1, 2, . . . , i+1) are calculated by operating with said converting mathematical operation on each pair of said plurality of pairs of values (IDj and Uj);
users temporary group-points (H(IDj,Uj)*Uj, j=1, 2, . . . , i+1) are calculated for each user in said chained key-issuing process, starting with said first successor user (User1) and ending with said successor user (User(i+1)), by exponentiating each said user public value (Uj) to the power of said user representing value (H(IDj,Uj));
a second intermediate group-point (P) is calculated by adding all said temporary group-points (P=H(ID(i+1),U(i+1))*U(i+1)+H(IDi,Ui)*Ui+H(ID(i−1),U(i−1))*U(i−1)+ . . . +H(ID1,U1)*U1);
a third intermediate group-point (Q) is calculated by adding said first intermediate group-point and said second intermediate group-point and the public value of said Certifying Authority (Q=H(m,T)*T+P+U0);
a fourth intermediate group-point (s*G) is calculated by exponentiating the generating group-point to the power of the first part (s) of said signature;
the value of said fourth intermediate group-point (s*G) is compared to that of said third intermediate group-point (Q) and the signature is determined as being valid in the case of equality.

6. A chained signature generation and verification system as recited by claim 5, wherein the chained-key issuing process comprises the steps of:
(a) permitting said Certifying Authority to select a generating group-point (G) whose exponentiations to various powers generate various group-points and a converting mathematical operation (H) which converts several input values into a scalar;
(b) permitting said Certifying Authority to posses a Certifying Authority private key (x0);
(c) permitting said Certifying Authority to posses a Certifying Authority public value (U0), obtained by exponentiating said generating group-point to the power of said Certifying Authority private key (U0=x0*G);
(d) permitting said issuing user (Useri) to possess said generating group-point (G) and said converting mathematical operation (H) and the identification details (ID(i+1)) of said successor user;
(e) permitting said issuing user (Useri) to possess an issuing user private key (xi), where, except for the case in which said issuing user is said Certifying Authority, said issuing user private key was provided to said issuing user at a preceding stage in the chained key-issuing process (in which Useri acted as a successor user in respect to an issuing User(i−1));
(f) permitting said issuing user (Useri) to calculate said successor user public value (U(i+1)) and said successor user private key (x(i+1)) wherein:
a successor user random value (k(i+1)) is generated and said successor user public value (U(i+1)) is calculated by exponentiating said generating group-point to the power of said successor user random value (U(i+1)=k(i+1)*G);
a successor user representing value (H(ID(i+1),U(i+1))) is calculated by operating with said converting mathematical operation on said successor user identification details (ID(i+1)) and said successor user public value (U(i+1));
said successor user private key (x(i+1)) is calculated by multiplying said successor user representing value (H(ID(i+1),U(i+1))) by said successor user random value (k(i+1)) and adding said issuing user private key (xi) to the product obtained by said multiplication (x(i+1)=H(ID(i+1),U(i+1))*k(i+1)+xi) and reducing the result modulo the order of said generating group-point; and
(g) permitting said issuing user (Useri) to submit said successor user public value (U(i+1)) and said successor user private key (x(i+1)) to said successor user (User(i+1)).

7. A certificate generation system as recited by claim 3, wherein the successor user (User(i+1)) is defined according to a method comprising the steps of:
permitting said successor user (User(i+1)) to generate a first random value (m(i+1)) and calculate a first intermediate group-point (m(i+1)*G) by exponentiating the generating group-point to the power of said first random value;
permitting said successor user to submit said first intermediate group-point (m(i+1)*G) to said issuing user (Useri);
permitting said issuing user to calculate a successor user public value (U(i+1)) and a successor user intermediate private key (p(i+1)), wherein:
a second random value (k(i+1)) is generated and a second intermediate group-point (k(i+1)*G) is calculated by exponentiating said generating group-point to the power of said second random value;
said successor user public value (U(i+1)) is calculated by adding said first intermediate group-point and said second intermediate group-point (U(i+1)=m(i+1)*G+k(i+1)*G);
a successor user representing value (H(ID(i+1),U(i+1))) is calculated in the way described;
said successor user intermediate private key (p(i+1)) is calculated by multiplying said successor user representing value (H(ID(i+1),U(i+1))) by said second random value (k(i+1)) and adding the issuing user private key (xi) to the product obtained by said multiplication (p(i+1)=H(ID(i+1),U(i+1))*k(i+1)+xi) and reducing the result modulo the order of said generating group-point; and
permitting said successor user to generate the successor user private key (x(i+1)) by calculating said successor user representing value (H(ID(i+1),U(i+1))) in the way described and multiplying said successor user representing value by said first random value (m(i+1)) and adding said successor user intermediate private key (p(i+1)) to the product obtained by said multiplication (x(i+1)=H(ID(i+1),U(i+1))*m(i+1)+p(i+1)) and reducing the result modulo the order of said generating group-point.

8. A chained certificate verification system as recited by claim 4, wherein the chained key-issuing process is defined according to a method comprising the steps of:
permitting said successor user (User(i+1)) to generate a first random value (m(i+1)) and calculate a first intermediate group-point (m(i+1)*G) by exponentiating the generating group-point to the power of said first random value;
permitting said successor user to submit said first intermediate group-point (m(i+1)*G) to said issuing user (Useri);
permitting said issuing user to calculate a successor user public value (U(i+1)) and a successor user intermediate private key (p(i+1)), wherein:
a second random value (k(i+1)) is generated and a second intermediate group-point (k(i+1)*G) is calculated by exponentiating said generating group-point to the power of said second random value;
said successor user public value (U(i+1)) is calculated by adding said first intermediate group-point and said second intermediate group-point (U(i+1)=m(i+1)*G+k(i+1)*G);
a successor user representing value (H(ID(i+1),U(i+1))) is calculated in the way described;
said successor user intermediate private key (p(i+1)) is calculated by multiplying said successor user representing value (H(ID(i+1),U(i+1))) by said second random value (k(i+1)) and adding the issuing user private key (xi) to the product obtained by said multiplication (p(i+1)=H(ID(i+1),U(i+1))*k(i+1)+xi) and reducing the result modulo the order of said generating group-point; and
permitting said successor user to generate the successor user private key (x(i+1)) by calculating said successor user representing value (H(ID(i+1),U(i+1))) in the way described and multiplying said successor user representing value by said first random value (m(i+1)) and adding said successor user intermediate private key (p(i+1)) to the product obtained by said multiplication (x(i+1)=H(ID(i+1),U(i+1))*m(i+1)+p(i+1)) and reducing the result modulo the order of said generating group-point.

8. A chained signature generation and verification system as recited by claim 5, wherein the successor user (User(i+1)) is defined according to a method comprising the steps of:
permitting said successor user (User(i+1)) to generate a first random value (m(i+1)) and calculate a first intermediate group-point (m(i+l)*G) by exponentiating the generating group-point to the power of said first random value;
permitting said successor user to submit said first intermediate group-point (m(i+1)*G) to said issuing user (Useri);
permitting said issuing user to calculate a successor user public value (U(i+1)) and a successor user intermediate private key (p(i+1)), wherein:
a second random value (k(i+1)) is generated and a second intermediate group-point (k(i+1)*G) is calculated by exponentiating said generating group-point to the power of said second random value;
said successor user public value (U(i+1)) is calculated by adding said first intermediate group-point and said second intermediate group-point (U(i+1)=m(i+1)*G+k(i+1)*G);
a successor user representing value (H(ID(i+1),U(i+1))) is calculated in the way described;
said successor user intermediate private key (p(i+1)) is calculated by multiplying said successor user representing value (H(ID₍ᵢ₊₁₎,U(i+1))) by said second random value (k(i+1)) and adding the issuing user private key (xi) to the product obtained by said multiplication (p(i+1)=H(ID(i+1),U(i+1))*k(i+1)+xi) and reducing the result modulo the order of said generating group-point; and
permitting said successor user to generate the successor user private key (x(i+1)) by calculating said successor user representing value (H(ID(i+1),U(i+1))) in the way described and multiplying said successor user representing value by said first random value (m(i+1)) and adding said successor user intermediate private key (p(i+1)) to the product obtained by said multiplication (x(i+1)=H(ID(i+1),U(i+1))*m(i+1)+p(i+1)) and reducing the result modulo the order of said generating group-point.
